(19) United States
(12) Patent Application Publication
(10) Pub. No.: US 2002/0168054 A1
(43) Pub. Date: Nov. 14, 2002

(54) Method and system for provisioning digital subscriber line facilities

(75) Inventors: Timothy Russell Klos, High Ridge, MO (US); Randall Stuart Leet, Pacific, MO (US); Gary Jay Martens, Florissant, MO (US); Susan Mary Merz, Saint Charles, MO (US); William Skiles Bowling, Florissant, MO (US); Terrence David Alan, St. Louis, MO (US)

Correspondence Address: GREENBLUM & BERNSTEIN, P.L.C., 1941 ROLAND CLARKE PLACE, RESTON, VA, 20191, US

(73) Assignee: SBC Technology Resources, Inc., Austin, TX

(21) Appl. No.: 09/853,722

(22) Filed: May 14, 2001

(51) Int. Cl. H04L 12/66; H04M 1/24; H04M 3/08; H04M 3/22

(52) U.S. Cl. 379/1.04; 379/1.01; 379/1.03

(57) ABSTRACT

A method and system include receiving at a provisioning server a service order to implement an asynchronous digital subscriber line (DSL) service from a service order entry system. The provisioning server identifies and assigns multiple facilities needed to implement the service order, including a remote terminal connectable to a terminal of a DSL subscriber and an optical concentrator device connectable to the remote terminal. The provisioning server determines an interface corresponding to each of the facilities, which are configured, based on interface specific instructions from the provisioning server, to implement the service order.

### BACKGROUND OF THE INVENTION

1. Field of the Invention

The present invention relates to the field of telecommunications. More particularly, the present invention relates to automated provisioning of digital subscriber line (DSL) services.

2. Acronyms

The written description provided herein contains acronyms which refer to various telecommunications services, components and techniques, as well as features relating to the present invention. Although some of these acronyms are known, use of these acronyms is not strictly standardized in the art. For purposes of the written description herein, the acronyms are defined as follows:

Access Identifier (AID)

Alternate Exchange Carrier Number (AECN)

Application Programming Interface (API)

Asymmetric Digital Subscriber Line (ADSL)

Central Office (CO)

Common Language Location Identifier (CLLI)

Command Line Interface (CLI)

Common Object Request Broker Architecture (CORBA)

Competitive Local Exchange Carrier (CLEC)

Constant Bit Rate (CBR)

Data Local Exchange Carrier (DLEC)

Discrete Multi-Tone (DMT)

Digital Loop Equipment (DLE)

Digital Subscriber Line (DSL)

Element Management System (EMS)

Feature Identifier (FID)

High Bit-Rate Digital Subscriber Line (HDSL)

Integrated Services Digital Network (ISDN)

Graphical User Interface (GUI)

Internet Protocol (IP)

Optical Carrier—Level 3 (OC3)

Optical Concentrator Device (OCD)

Rate Adaptive Digital Subscriber Line (RDSL)

Remote Terminal (RT)

Service Management System (SMS)

Service Order Analysis and Control (SOAC)

Transmission Control Protocol/Internet Protocol (TCP/IP)

Target Identifier (TID)

Transactional Language (TL)

Unspecified Bit Rate (UBR)

Variable Bit Rate (VBR)

Virtual Channel Identifier (VCI)

Virtual Path Identifier (VPI)

3. Background Information

Digital subscriber line (DSL) is a telecommunications service that enables high-speed data access across conventional copper telephone lines to subscribers' terminals. Because DSL incorporates use of conventional telephone lines, there is no need for expensive, digitally dedicated systems and lines, such as integrated services digital network (ISDN) and T1. Yet, like ISDN and T1 systems, DSL provides the subscriber with a continuously active digital service capability, e.g., an uninterrupted connection to the Internet or other packet-switched data network, without affecting conventional, analog telephone capability.

There are a variety of DSL types, each of which has unique characteristics. Asymmetric digital subscriber line (ADSL) service, in particular, is DSL tailored to accommodate a typical subscriber premises in that DSL allots greater bandwidth to receive data from the network than to transmit from the subscriber terminal. One common limitation among all types of DSL services is the relatively short distance within which a DSL subscriber terminal must be located from the serving central office (CO), which significantly restricts the number of potential DSL subscribers. For example, although DSL supports a wide range of upstream and downstream data rates, it has a distance limitation of approximately 18,000 feet from the serving CO. The distance limitation is a result of signal attenuation over conventional copper telephone lines.

Providing DSL services to subscribers beyond the conventional 18,000-foot radius requires incorporation of remote terminals (RT) in the telecommunication network. Each RT is connected by optical fiber (e.g., OC3) to a CO switch that includes an optical concentrator device (OCD). Unlike conventional copper lines, optical fiber is not affected by signal attenuation and virtually eliminates distance restrictions. The RTs are placed in close proximity to the subscribers, irrespective of respective CO switch locations. RTs are less expensive and less cumbersome than CO switches, and can therefore efficiently extend the reach of each CO well beyond the existing 18,000-foot limitation (although the subscribers, who are ultimately accessed via copper lines, must still be within 18,000 feet of an RT).

A present difficulty with RT-based DSL is that there is no standardized procedure for provisioning the entire system, regardless of the network element types and specific service requirements. Provisioning RT-based DSL is currently a two-step process: establishing DSL in the RT on a specified subscriber port and building a corresponding logical cross-connection in the connected OCD. Because numerous vendors manufacture RTs and OCDs, there currently is no standard provisioning process, at least from an interfacing perspective. Rather, each vendor offers its own proprietary interfacing and software management system, typically invoked through a graphical user interface (GUI) or a command line interface (CLI). Protocols for CLI, for example, vary from vendor to vendor and most offer specific implementations of the transaction language 1 (TL1) command set.

Some vendors offer a common object request broker architecture (CORBA) interface, for example, while others invoke a set of application programming interface (API) library routines. Furthermore, RTs and OCDs from some vendors are provisioned directly in the network elements, while others are subject to restricted provisioning through the respective vendor's proprietary element management system (EMS). Provisioning DSL directly in the network elements using vendor-supplied tools requires the service provider to have access to each vendor's tool set and necessitates an in-depth understanding of each. Accommodating and integrating the various vendor facilities complicates the expensive and time-consuming provisioning of DSL.

### BRIEF DESCRIPTION OF THE DRAWINGS

The present invention is further described in the detailed description that follows, by reference to the noted plurality of drawings by way of non-limiting examples of embodiments of the present invention, in which like reference numerals represent similar parts throughout several views of the drawings, and in which:

FIG. 1 is a block diagram showing an exemplary network capable of providing DSL services, according to an aspect of the present invention;

FIG. 2 is an exemplary flow chart of a DSL service order provisioning process, according to an aspect of the present invention;

FIG. 3 is an exemplary flow chart of the units of work derivation process within the DSL service order provisioning process shown in FIG. 2, according to an aspect of the present invention;

FIG. 4 is an exemplary flow chart of a continuation of the DSL service order provisioning process shown in FIG. 2, according to an aspect of the present invention;

FIG. 5 is an exemplary flow chart of the RT provisioning process within the DSL service order provisioning process shown in FIG. 4, according to an aspect of the present invention; and

FIG. 6 is an exemplary flow chart of the OCD provisioning process within the DSL service order provisioning process shown in FIG. 4, according to an aspect of the present invention.

### DETAILED DESCRIPTION OF EMBODIMENTS

The present invention relates to enabling RT-based DSL services by automating the provisioning process, thereby minimizing the complexity and cost of subscriber installation.

An aspect of the present invention provides a method for provisioning a digital subscriber line (DSL) service in a telecommunications network, which includes receiving at a provisioning server a service order requesting the DSL service from a service order entry system and assigning multiple facilities needed to implement the service order based on provisioning data indicated by the service order. The facilities include at least a remote terminal connectable to a terminal of a DSL subscriber and an optical concentrator device connectable to the remote terminal. The method determines an interface corresponding to each of the facilities, each interface converting the service order data into a specific protocol corresponding to the assigned facility. Each of the facilities is configured, using the corresponding interface, to implement the service order based on instructions from the provisioning server.

The method for provisioning a DSL service may further include determining at least one path interconnecting the facilities and a subscriber port of the remote terminal. The subscriber port is configured to connect with the DSL subscriber terminal. A cross-connection in at least one of the facilities may be determined and implemented to enable at least one path interconnecting the facilities and the subscriber port. Furthermore, configuration data may be stored in a system database. The configuration data includes data that identifies the facilities assigned to implement the service order, the at least one path interconnecting the facilities and the subscriber port of the remote terminal, and the cross-connection in the at least one of the facilities. The method may further determine whether the service order includes erroneous data. When the service order includes erroneous data, an error message identifying the erroneous data is displayed at a graphical user interface (GUI). Input is received from the GUI to correct the erroneous data.

According to another aspect of the invention, the provisioning data is derived based on the provisioning data indication in the service order. Also, the service order may indicate the provisioning data by either providing the provisioning data or providing a profile identification that corresponds to parameters that define the DSL service.

Another aspect of the present invention provides a method for provisioning a DSL service in a telecommunications network, which includes receiving a service order, which corresponds to a DSL subscriber, at a common server through a service order entry system; converting the service order into provisionable steps; and determining facility assignment data related to each of a number of facilities needed to implement the provisionable steps. The facility assignment data includes identification of at least a remote terminal and a subscriber port, connectable to a terminal of the DSL subscriber, and an optical concentrator device connectable to the remote terminal. The method further includes determining an interface for each of the facilities, each interface enabling communication with a corresponding facility, and configuring each of the facilities to implement the service order based on instructions communicated from the common server to each facility using the corresponding interface.

The configuring of each of the facilities to implement the service order includes building, deleting or changing at least one virtual path over an optical fiber connection between the remote terminal and the optical concentrator device. Building at least one virtual path over an optical fiber connection between the remote terminal and the optical concentrator device includes providing a network-side port at the remote terminal configured to connect with the subscriber port, communicating to the optical concentrator device the identity of the network-side port, and configuring the optical concentrator device to support the virtual path to the network-side port of the remote terminal. Deleting at least one virtual path over an optical fiber connection between the remote terminal and the optical concentrator device includes disconnecting a network-side port at the remote terminal from the subscriber port, communicating to the optical concentrator device the identity of the network-side port, and configuring the optical concentrator device to delete support of the virtual path to the network-side port of the remote terminal. The configuring of the facilities to implement the service order may also include building, deleting or changing at least one cross-connection in at least one of the facilities.

The method for provisioning a DSL service may further include formatting data from the service order into a common internal format prior to converting the service order into provisional steps. Also, the method may include validating an intent of the service order with respect to a state of a port of the remote terminal associated with the DSL subscriber and provisioning the service order in the remote terminal upon successful validation.

According to another aspect of the present invention, errors are identified related to at least one of the service order and the provisioning of the DSL service. The errors are displayed information regarding the errors at a GUI, which is configured to enable a user to analyze and respond to the errors.

The method for provisioning a DSL service may further include enqueuing the provisionable steps after determining the facility assignment data related to each of a plurality of facilities needed to implement the provisionable steps. The provisionable steps are sequentially dequeued for implementation on a scheduled provisioning date, prior to determining the interface for each of the plurality of facilities. Furthermore, the method may include receiving service profile data, which includes at least one parameter related to the service order, related to at least one service from a service provider. The service profile data is stored in a system database. Then, each of the facilities is configured to implement the service order additionally based on the service profile data.

Another aspect of the present invention provides a system for provisioning a DSL service in a telecommunications network, including a server, multiple network facilities and a system database. The server receives a service order for the DSL service from a service order entry system. The system database stores the service order and multiple interfaces corresponding to the multiple network facilities. The network facilities are connectable to the server and a terminal of a DSL subscriber. The server assigns provisioning facilities from among the network facilities needed to implement the service order. The provisioning facilities include at least one remote terminal and at least one optical concentrator device, such that the remote terminal is connectable to the optical concentrator device by an optical fiber line. Also, the server directs configuration of each of the provisioning facilities, using an interface identifier retrieved from the system database corresponding to each of the provisioning facilities, to implement the service order.

In one aspect of the present invention, the remote terminal includes a subscriber port, which is configured to connect with a DSL subscriber terminal. The server enables at least one path interconnecting the facilities and the subscriber port of the remote terminal. Furthermore, the remote terminal and the optical concentrator device determine and implement a cross-connection to enable the at least one path interconnecting the facilities and the subscriber port. The system database then includes configuration data that identifies the facilities assigned to implement the service order, the at least one path interconnecting the facilities and the subscriber port of the remote terminal, and the cross-connection in the at least one of the plurality of facilities.

In anther aspect of the present invention, the system for provisioning a DSL service further includes a GUI connected to the server. The GUI is configured to interface with the server, the system database and at least one of the network elements. When the service order includes erroneous data, the GUI displays an error message, which identifies the erroneous data. The GUI then may receive input from an operator in response to the erroneous data.

Another aspect of the present invention provides a system for provisioning a DSL service in a telecommunications network. The system includes a service order entry system that receives a service order for the DSL service from a DSL service provider and a server that receives the service order from the service order entry system. The system further includes a number of network facilities connectable to the server and a terminal of a subscriber desiring the DSL service. The system further includes a facility inventory system and a system database, both of which are connected to the server. The facility inventory system stores facility information regarding each of the network facilities. The facility information includes a type, a location and an availability of each of the network facilities. The system database stores data relating to the service order and a number of interfaces corresponding to the network facilities.

The server communicates with the facility inventory system to determine provisioning facilities from among the network facilities needed to implement the service order received from the service order entry system. The provisioning facilities include at least one remote terminal and a subscriber port and at least one optical concentrator device. The remote terminal is connectable to the optical concentrator device by an optical fiber line. The server also directs configuration of each of the provisioning facilities using corresponding interfaces retrieved from the system database to implement the service order.

The system for provisioning a DSL service may further include a GUI connectable to the server that enables interaction by a network operator with at least the server, the network facilities or the system database. The server may identify errors related to at least one of the service order and the provisioning of the DSL service. Then, information regarding the errors is displayed at the GUI and error responses are sent from the GUI to the server.

The system may also include an interface configured to connect a GUI of the DSL service provider with the server. The system database stores service profile data related to at least one service of the DSL service provider, where the service profile data includes at least one parameter related to the service order. The provisioning facilities are then configured to implement the service order additionally based on the service profile data.

According to another aspect of the present invention, the configuration of each of the provisioning facilities, using a corresponding interface retrieved from the system database to implement the service order, includes one of building, deleting or changing at least one virtual path over the optical fiber connection between the remote terminal and the optical concentrator device. Building the virtual path over the optical fiber connection between the remote terminal and the optical concentrator device includes providing a network-side port at the remote terminal configured to connect with the subscriber port, communicating to the optical concentrator device the identity of the network-side port and configuring the optical concentrator device to support the virtual path to the network-side port of the remote terminal. Deleting the virtual path over the optical fiber connection includes disconnecting a network-side port at the remote terminal from the subscriber port, communicating to the optical concentrator device the identity of the network-side port and configuring the optical concentrator device to delete support of the virtual path to the network-side port of the remote terminal.

Another aspect of the present invention provides computer readable medium for storing a computer program that provisions a DSL service in a telecommunications network. The computer readable medium includes a receiving source code segment that receives a service order requesting the DSL service from a service order entry system, an assigning source code segment that assigns facilities needed to implement the service order based on provisioning data indicated by the service order, a determining source code segment that determines an interface corresponding to each of the facilities, and a configuring source code segment that configures each of the facilities. The facilities are configured using the corresponding interface to implement the service order based on instructions from a provisioning server. The facilities include at least a remote terminal connectable to a terminal of a DSL subscriber and an optical concentrator device connectable to the remote terminal. Each interface converts the service order data into a specific protocol corresponding to the assigned facility.

The computer readable medium for storing a computer program that provisions a DSL service may further include a path determining source code segment that determines at least one path interconnecting the facilities and a subscriber port of the remote terminal, where the subscriber port is configured to connect with the DSL subscriber terminal. The computer readable medium may also include a cross-section determining source code segment that determines and implements a cross-connection in at least one of the facilities to enable the at least one path interconnecting the facilities and the subscriber port. The computer readable medium may also include a memory source code segment that stores configuration data in a system database. The configuration data includes data identifying the facilities assigned to implement the service order, the path interconnecting the facilities and the subscriber port of the remote terminal, and the cross-connection in the at least one of the facilities.

According to an aspect of the present invention, the provisioning data is derived based on the provisioning data indication in the service order. Also, the service order may indicate the provisioning data by providing the provisioning data or providing a profile identification that corresponds to parameters that define the DSL service.

Furthermore, the computer readable medium for storing a computer program may include an error detection source code segment that determines whether the service order includes erroneous data. When the service order is determined to have erroneous data, the error detection source code segment initiates at a GUI a display of an error message, which identifies the erroneous data. The error detection source code segment may then receive input from the GUI to correct the erroneous data.

Another aspect of the present invention provides a computer readable medium for storing a computer program that provisions a DSL service in a telecommunications network and includes a receiving source code segment that receives a service order at a common server through a service order entry system and a converting source code segment that converts the service order into provisionable steps. The service order corresponds to a DSL subscriber. The computer readable medium further includes a facility assignment source code segment that determines facility assignment data related to each of a plurality of facilities needed to implement the provisionable steps. The facility assignment data includes identification of at least a remote terminal and a subscriber port, connectable to a terminal of the DSL subscriber, and an optical concentrator device connectable to the remote terminal. The computer readable medium further includes an interface determining source code segment that determines an interface for each facilities and a configuring source code segment that configures each of the facilities to implement the service order based on instructions communicated from the common server to each of the facilities using the corresponding interface. Each interface enables communication with a corresponding facility.

Providing DSL to the mass market requires cost effective deployment. Standard service order entry systems provide the ordering mechanism, but no single provisioning system provides the ability to establish, change or disconnect the service, regardless of the network elements and facilities involved. The present invention accepts typical mass market service orders and provisions the requested DSL service in a variety of network element architectures. The improved provisioning capability includes provisioning DSL in any vendors' network elements by converting standard service order requests into specific protocols. Using communications interfaces, vendor specific “commands” are issued to the RTs and the OCDs to establish the DSL service, enabling an automated flow of service orders and thereby eliminating the manual interaction conventionally required. The present invention provides not only the capability of translating service orders from existing service order entry systems, but also supports a GUI that can, as an alternative, be used to provision DSL and query the various network elements.

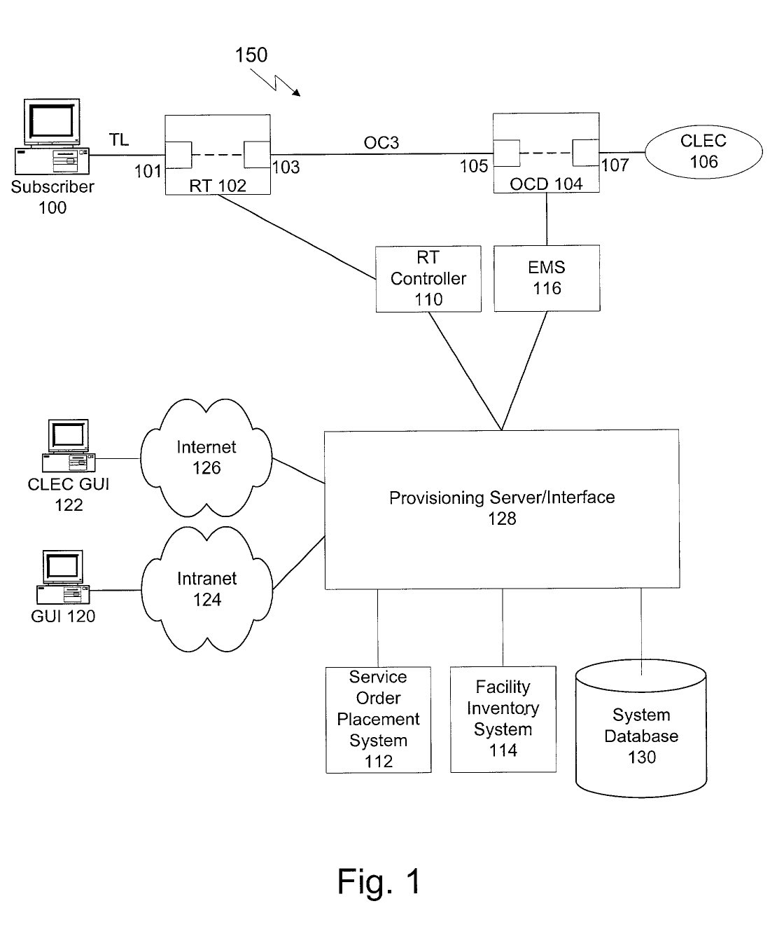

FIG. 1 is a block diagram depicting an exemplary telecommunications network 150 in association with the present invention, for providing all types of DSL, including ADSL and high bit-rate DLS (HDSL). The network includes a remote terminal (RT) 102 and an optical concentration device (OCD) 104, which is connected to the RT 102 via an optical fiber line, such as OC3. The RT 102 includes a subscriber-side DSL port 101 and an OCD-side port 103. The port 101 may be configured to connect a subscriber 100 to the RT 102 via conventional copper telephone line TL. Similarly, the OCD 104 includes an RT-side port 105 and a provider-side port 107. The port 107 is configured to connect the DSL provider with the network, which may include, for example, a competitive local exchange carrier (CLEC) 106, a data local exchange carrier (DLEC) or the like.

The RT 102 is any DSL compatible system, such as a LiteSpan 2000 and 2012, manufactured by Alcatel; a Universal Modular Carrier (UMC) 1000, manufactured by Advanced Fibre Communications, Inc. (AFC); or an AnyMedia Optical Network Unit, manufactured by Lucent Technologies, Inc. The RT 102 is configured to connect a series of subscriber ports to optical fiber, e.g., OC3, ports, which are connected to the associated OCD 104. The OCD 104 is provided in the central office and may be a CBX-500 and a GX-550 multi-service wide area network switch (supporting ATM functionality), manufactured by Lucent Technologies, Inc., or a Cisco 6400, manufactured by Cisco Systems, Inc. The OCD 104 enables communication capability between the multiple channel RT 102 and the service provider. A single OCD 104 services multiple RTs, each of which serves multiple subscribers.

In an embodiment of the invention, the RT 102 and the OCD 104 are provisioned through an RT controller 101, e.g. a central office terminal (COT), and an element management system (EMS) 116, respectively. However, certain vendor's RT systems, such as the AFC UMC 1000, require provisioning of the RT 102 through an EMS. An exemplary EMS 116 includes NavisCore/NavisXtend available from Lucent Technologies, Inc., used in conjunction with the CBX-500 and the GX-550, or Cisco Element Management Framework (CEMF), available from Cisco Systems, Inc., used in conjunction with the Cisco 6400.

The remainder of the network 150 centers around the provisioning server 128, which is an application server and functions, in part, to interface the various network elements. Connected to the provisioning server 128 are the RT controller 110, the EMS 116, a service order placement system 112 and a facility inventory system 114. The network provider accesses the provisioning server 128 using, for example, a GUI 120 via an intranet 124. The GUI 120 can be used for any variety of interactions with the network 150, including correcting service order and provisioning errors, rebuilding service orders, querying network elements to determine respective provisioning statuses, accessing a system database 130, requesting various reports, and maintaining user access and permissions.

To enable interfacing with the network 150, the GUI 120 incorporates a web browser, such as Microsoft Internet Explorer, available from Microsoft Corporation. In one embodiment, the GUI 120 is an IBM Pentium based PC, running Microsoft WINDOWS operating system; and running the Microsoft Internet Explorer web browser software. The GUI 120 accesses the network 150 via an intranet web server running the Unix operating system and the IBM Websphere web application server software, available from IBM Corporation.

In an embodiment of the invention, the CLEC 106 accesses the provisioning server 128 via an independent CLEC access, which includes a CLEC GUI 122, operating as a web client in conjunction with a web server (not pictured), via the Internet 126. In an embodiment of the invention, the CLEC GUI 122 is a Broadband Ordering Profile (BOP) GUI that provides to the CLEC a method for profiling its services.

Also connected to the provisioning server 128 is the system database 130, which includes, for example, historical tracking data, service order data, reference tables, error data and reformatted subscriber data, discussed below. The CLEC 106 is enabled limited access to database 130 to provide service profile data particular to the CLEC 106 (or similarly situated carrier). The service profile data includes information such as service codes and associated service grades and data rates, which are used to determine operational factors, such as noise level, related to particular subscribers. The network 150 is dynamic, in that new network elements and vendor architectures are routinely introduced. Configuration data associated with new elements and architectures is stored in the reference tables in system database 130, and can be updated manually, e.g., via the GUI 120. The updated configuration data assures accurate provisioning of the selected RT, OCD, EMS and other network elements, even as these elements change over time. The provisioning system is therefore kept current with virtually no maintenance requirements.

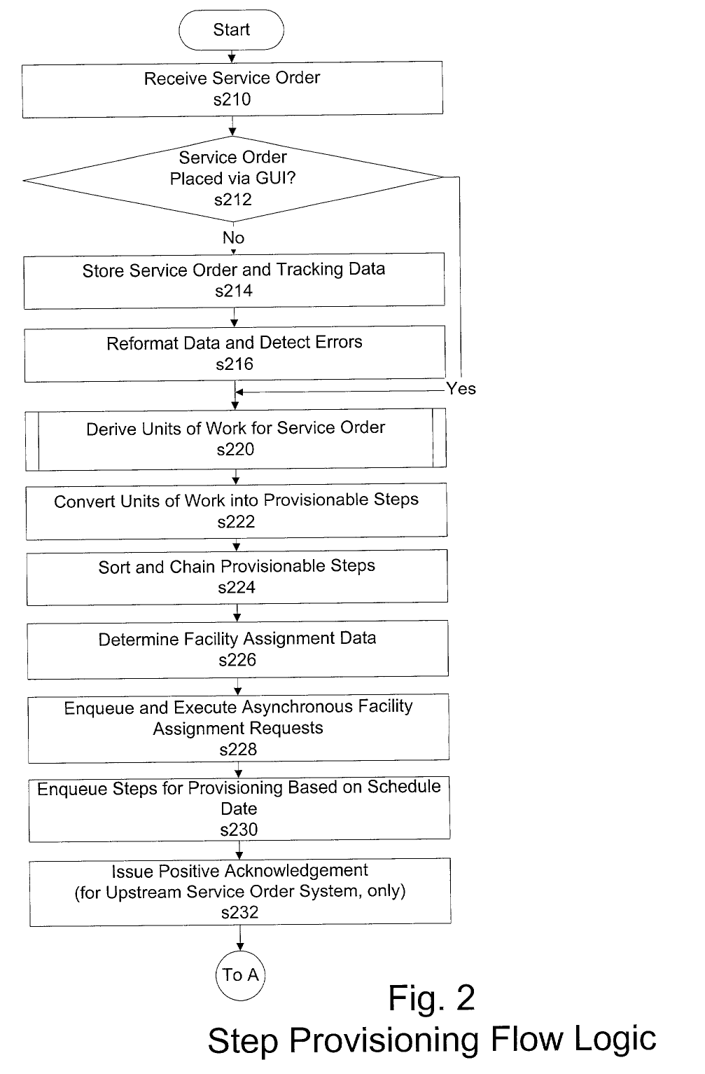

FIG. 2 is a flow diagram depicting an exemplary DSL service order provisioning process, according to an embodiment of the present invention. At step s210, the provisioning server 128 receives a subscriber service order requesting a particular action related to DSL services. The possible actions are deleting, adding or changing a service. In one embodiment, changing a service is implemented by first deleting the existing service and then adding the new service. Therefore, as a practical matter, the DSL service order actions include only deleting and adding services.

DSL service orders include a variety of information necessary to identify the subscriber, the subscriber's equipment, the type of service requested, network routing and other criteria. The service orders include, for example, the subscriber's circuit identifier and telephone number. The circuit is the path connecting the subscriber 100 to the CLEC 106. The service orders may also contain a description of the type of DSL to provision, such as unspecified bit rate (UBR), constant bit rate (CBR), variable bit rate (VBR) and rate adaptive DSL (RDSL). Routing information is also included to identify, for example, a virtual path identifier (VPI) and a virtual channel identifier (VCI), which define the logical data path from the subscriber 100 to the CLEC 106. The service order routing information includes designation of the appropriate subscriber port 101 of the RT 102 and CLEC port 107 of the OCD 104 to implement the requested service.

The service order information may further contain discrete multi-tone (DMT) parameters, such as data rates, noise levels and power characteristics, related to the profile data provided by the CLEC 106 and stored in the system database 130, as well as a universal service order code (USOC), which denotes DSL, and sets of feature identifiers (FIDs) to identify the specific characteristics to be provisioned. The service order may include the complete set of DMT parameters, or alternatively, the service order may include a profile identifier, which represents a desired configuration, to shorten the service order process. The entire collection of appropriate DMT parameters needed to provision the RT 102 for a specific service order can then be retrieved from the service profile reference table in system database 130, using a profile identifier provided in the service order. The DMT parameters may include, for example, minimum and maximum data rates (upstream and downstream); minimum, maximum and target noise levels; minimum and maximum interleaved channel delay; and maximum aggregate power and power spectral density.

Each type of DSL also has specific characteristics that, like the DMT parameters, may be too cumbersome to provide in every service order. These characteristics are used to provision the OCD and are likewise retrieved from the service profile reference table in the system database 130 using an identifier specified in the service order. The combination of the profile identifier and the specific DSL service type provides a unique key for querying the table.

The service orders are entered through any “upstream” service order entry system 112, flowing to a service order placement system, known in the art, such as a service order analysis and control (SOAC) system. The service order placement system 112 communicates with the provisioning server 128 using a known protocol, such as TOPCOM, version 5.5.1, available from Telecordia Technologies, Inc., over a transmission control protocol/internet protocol (TCP/IP) interface. The service order placement system 112 determines the management system involved in implementing the requested service, formats the service order accordingly and sends it to the appropriate system. For example, a request for an advanced intelligent network (AIN) service is routed to an appropriate service management system (SMS), whereas a request for a DSL service is routed to the provisioning server 128. The service order placement system 112 may determine the routing based on a service order code associated with the requested service.

A service order may be initiated internally by the network provider based on a specific request of the CLEC 106, or the service order may be initiated directly by the CLEC 106. A negative acknowledgement is sent to the service order placement system 112 to indicate service order creation errors.

The data contained in the service orders may vary in content and format. For example, service order data may be concatenated and depicted as a single data item, or alternatively, each distinct data item may be portrayed individually. Service orders may include a telephone number of the subscriber 100, which is specifically tagged by the service order placement system 112 to identify the service order to the provisioning server 128. The service order contains several additional FIDs, including a serial circuit identification number to identify the CLEC 106 meet point on the OCD 104 and cross-references to a serial circuit identification number of the circuit between the subscriber's terminal and the RT 102. Additional FIDs may include a service profile number relating to the requested service and an operating company number to identify the correct CLEC profile, as well as additional service provider parameters, such as the alternate exchange carrier number (AECN) of the CLEC 106. VPI and VCI information for the RT 102 and the OCD 104 is also included in the service order. To achieve the highest degree of flexibility, all service order data is converted into a standardized internal format prior to provisioning DSL. To simplify the internal processing logic, a single function performs the service order data conversion in an embodiment of the invention.

At step s212 of FIG. 2, the provisioning server 128 identifies the service order entry system. In particular, step s212 determines whether the service order data has been placed using the GUI 120 via the intranet 124. If so, the service order data is already compatibly formatted with the network 150 and the process proceeds directly to process step s220 to derive units of work. Through the GUI 120, the provisioning server 128 may be instructed to query arbitrary network elements and process, 0.store or display retrieved data in a consistent format.

Note that the GUI 120 is not a typical conduit for entering new service orders. Rather, the GUI 120 is involved periodically when a service order entered through the service order placement system 112 is invalid, contains incorrect or missing data, or is otherwise erroneous and fails to provide the necessary provisioning information to the provisioning server 128. Depending on the type of error, discussed below in detail, portions of the service order may be corrected or may be manually entered via the GUI 120. For example, the network provider may enter missing data or request specific provisioning actions through the GUI 120. In fact, the provider may create and submit an entire service order from the GUI 120. Once the service order is received from the GUI 120 through the intranet 124, the provisioning server 128 treats it the same as any service order received from the service order placement system 112.

The GUI 120 can support extensive functionality. For example, in an embodiment of the invention, service order information is selected and viewed by the network provider based on the service order number or the subscriber's circuit identification number. The GUI 120 includes an order initiation screen that enables the network provider to update network elements, disconnect services, change services, resubmit service orders having provisioning errors and resubmit service orders awaiting manual coordination or assistance. The GUI 120 also includes a manual intervention schedule, used to resolve order and provisioning errors, which displays any variable data associated with the error, identifies corrective action and formats the corrective action to be entered into the provisioning flow. When the corrective action or other GUI initiated provisioning is activated, a provisioning message is sent to the RT 102, via the RT controller 110, and then to the OCD 104 via the associated EMS 116. The GUI 120 may also provide various administrative screens that enable access to GUI operator parameters to create operator profiles. The GUI 120 may also be configured to query each RT and OCD, as well as benchmarking and pending order data based on subscriber circuit identification.

In an embodiment of the invention, the GUI 120 further provides an OCD circuit exhaust notification screen, which includes the e-mail address of each service provider, such as CLEC 106. The service provider then receives notice of OCD circuit exhaust at the listed e-mail address based on a predetermined threshold circuit capacity. In other words, the service provider is informed by e-mail when its dedicated OCD circuit has reached, for example, 75 percent of available capacity. The notification enables the service provider to take appropriate responsive action.

If the service order is sent from the service order placement system 112, raw data of the service order is stored in the system database 130, along with historical tracking data related to the order, at step s214. Historical tracking data includes, for example, all relevant data identifying the service order, the flow of every provisioning system program that worked on the service order and entries for every circuit and corresponding steps in the service order. As discussed below, the historical tracking data is updated throughout the provisioning process to provide a specific record of the DSL service orders. The historical tracking data therefore further includes implementation information, such as the state of the particular service order, timestamps of various actions performed pursuant to the service order and the errors, if any, encountered during the provisioning process.

At step s216, the raw data is reformatted through conversion logic to a standardized internal format, i.e., consistent with the format of the service order data entered through the GUI 120. During reformatting, detection of any invalid data results in an error and service order rejection. When the upstream service order data is successfully reformatted, the process proceeds to process step s220 to derive units of work for additional processing common to data entered via both the GUI 120 and the service order placement system 112.

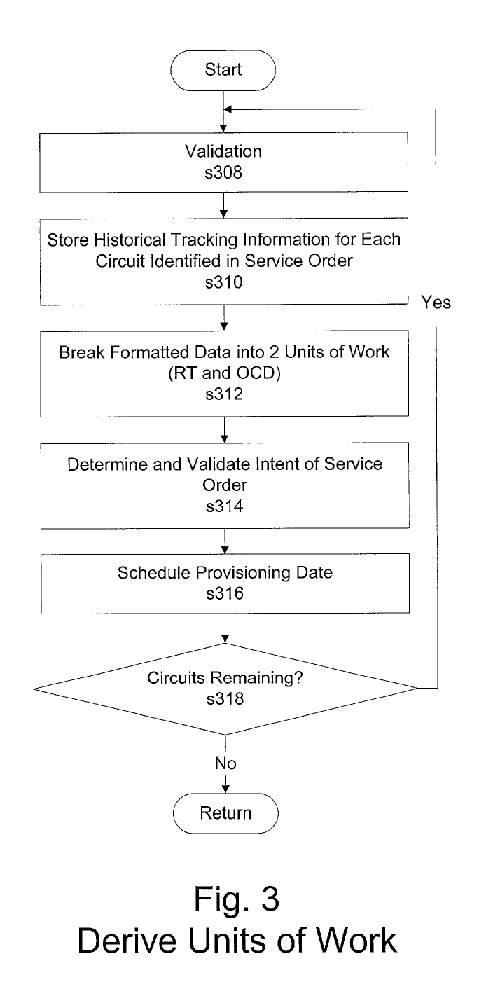

FIG. 3 depicts the process for deriving units of work, indicated by process step s220 of FIG. 2. Division into units of work is necessary because multiple requests, telephone numbers and subscribers may be included in a single service order. Each telephone number in a service order is associated with one or more unique DSL circuits, for example a UBR and a CBR PVC.

The provisioning server 128 first validates the required fields associated with the circuit at step s308. Validation ensures that the service order related to the subject circuit is legitimate. The validation process operates on the format and content of the service order data, as well as the validity of the request. Each circuit field in the service order is analyzed to ensure, for example, that the data format is valid and, when possible, the data itself is correct. If required fields or data are missing or otherwise invalid, an error results and the service order is rejected with respect to the particular circuit. At step s310, the historical tracking information related to the circuit is stored in the system database 130.

The internally formatted data is then broken into two units of work at step s312, corresponding to the RT and the OCD to be provisioned to accommodate the DSL service. At step s314, the provisioning server 128 determines and validates the intent of the service order with respect to the circuit, e.g., adding or deleting a DSL service, and whether that intent is valid. Validation of the intent data may include, for example, determining whether required data is missing, the data is correctly formatted, the data content is correct and the VPI/VCI values are unique. Furthermore, validation ensures that the request is legal based upon the subscriber's current service status. Validation must consider future pending service order requests that will modify the state of the subscriber port 101 and potentially conflict with the current service order's intent on the scheduled provisioning date, discussed below. When the intent of the service order cannot be determined or when the intent is invalid, an error is generated and the service order with respect to the particular circuit is rejected.

Once the intent data is validated, a provisioning date is established at step s316 based, for example, based on the requested activity and geographic region. At step s318, the provisioning server 128 determines whether the service order identifies any other circuits that have not yet been converted into units of work. When there are unprocessed circuits remaining, the process returns to step s308 and the logic is repeated until units of work have been derived for all of the circuits identified in the service order. When there are no remaining circuits, as determined at step s318, the process returns to step s222 of FIG. 2.

At step s222 the units of work related to each circuit are converted into provisionable steps. The provisionable steps are sorted by activity and “chained” together in a predetermined order at step s224. The types of activities are deleting and adding DSL services. The sorting step includes subdividing the changing activities into deleting and adding activities. The sorted activities are then chained serially with all deletion activities first, followed by the addition activities. Chaining the activities in this order prevents attempts to add a new service related to a subscriber port where a preexisting service has not yet been deleted. Of course, additions could precede deletions if desired.

At step s226, the provisioning server 128 determines the facility assignment data to accommodate provisioning of the service orders based on information from the service order and the facility inventory system 114. In an embodiment of the invention, the facility inventory system 114 implements a SWITCH digital loop equipment (DLE) inventory application, available from Telecordia Technologies, Inc. The facility inventory system 114 contains identification data of every facility in the network, including the make, manufacturer, location and connections to other facilities, including customer (i.e., subscriber) ports. Although the service order contains general information related to the type and characteristics of the desired DSL service, it does not necessarily contain all facility assignment data. Therefore, the provisioning server 128 identifies the specific equipment, e.g., the RT 102, the RT controller 110, the OCD 104 and the EMS 116, associated with the subscriber and the provisioning request, based on data from the facility inventory system 114, the location of the subscriber, the specific service requested and similar implementation enabling information. Once determined, the facility assignment data is stored in the system database 130 and the limited use facilities, such as the subscriber port 101 of the RT 102, are removed from the inventory to prevent redundant assignment. Of course, when the service order provides the facility assignment data, the provision server 128 does not need to identify the specific equipment.

For disconnect orders, the provisioning server 128 simply retrieves the facility assignment data from the system database 130. The data is available because the particular facilities were previously assigned at the time the service was added. Note that, in an embodiment of the invention, a requirement for manual review of the DSL service, e.g., via the GUI 120, may be stored in the system database 130 along with the disconnect order, to prevent an entirely automatic disconnection on the scheduled date. With respect to requests for new connections, the provisioning server 128 initiates a facility assignment query to determine the appropriate facilities and associated data, described above. When a service order is placed by way of the GUI 120, the facility assignment data may also be retrieved from a GUI assignment table.

At step s230 the provisionable steps, sorted and chained at step s224, are enqueued for provisioning based on the scheduled provisioning date. Transaction management software, such as TUXEDO, version 6.4, available from BEA Systems, Inc., may implement the queue functionality. The provisionable steps remain in the queue until the scheduled date. Any missing data, such as target ID and port identifier data, may be added while the step is in queue. Once the steps have been enqueued, a positive acknowledgment is issued at step s232 to the service order placement system 112. No such acknowledgment is necessary for service orders entered via the GUI 120 because queue information and order status are routinely accessible through the GUI 120.

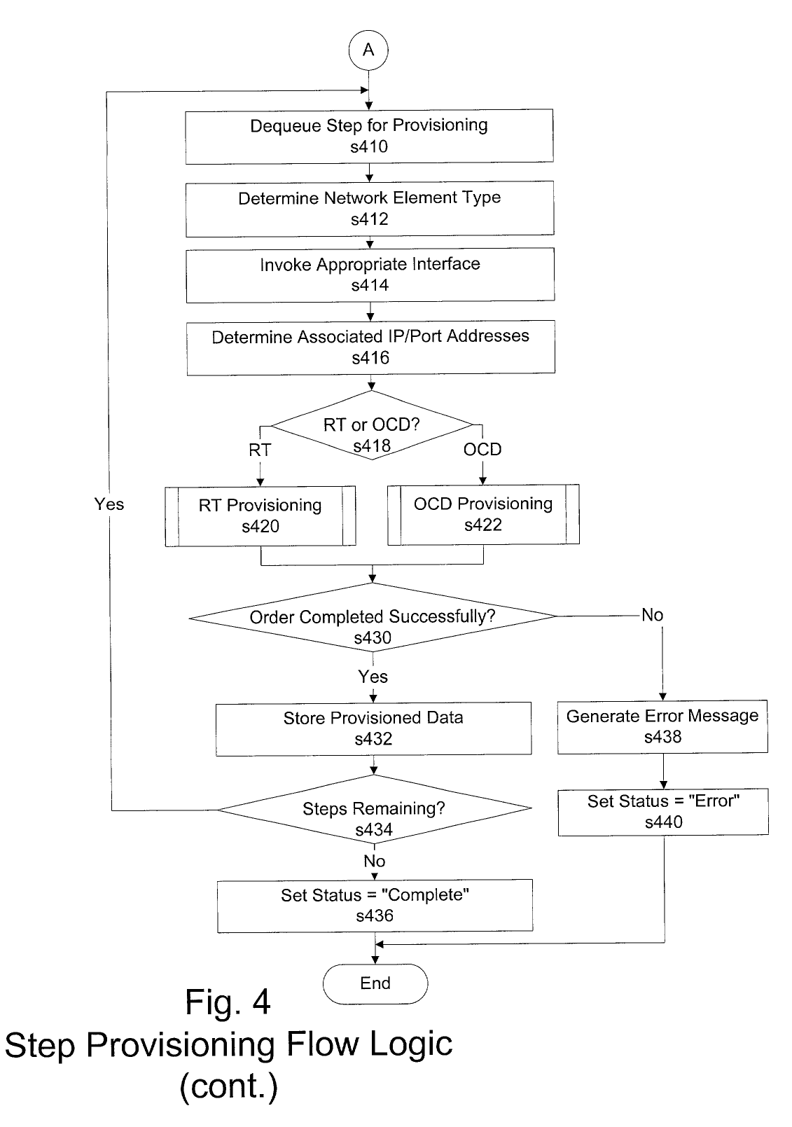

On the scheduled provisioning date, the exemplary process of FIG. 2 continues at FIG. 4. The provisioning server 128 consecutively dequeues each provisionable step at step s410 for implementation. The network element type related to the provisionable step is identified at step s412, based on the previously determined facility assignment data, in order to determine, for example, whether the provisionable step is directed to the RT 102 or the OCD 106 and what specific vendor equipment is involved.

At step s414, the provisioning server 128 invokes the appropriate interface for communicating with the previously assigned facilities needed to implement the service order. The type of interface is based on the network element type, identified in step s412 above, and its corresponding communications protocol. As discussed above, the various vendors each require a specific protocol to communicate with their respective network facilities. For example, with respect to RT 102, the provisioning logic associated with an Alcatel LiteSpan 2000 RT requires an Alcatel compatible protocol for provisioning through an RT controller, such as that described for example at pages 6B-1-2, 16, 40, 73-75, 133-135 and 464 of Alcatel LiteSpan 2012 Access Platform TL1 Messages, OSP363-355-502 (Draft 3), dated Feb. 21, 2000, the contents of which are expressly incorporated herein by reference. However, the provisioning logic associated with an AFC UMC 1000 RT requires an AFC protocol for provisioning through an EMS. Likewise, with respect to the EMS 116, for example, the provisioning logic associated with the NavisCore EMS API functionality, used to provision the Lucent CBX-500 or GX-550 550 switch, requires a Lucent compatible protocol, such as that described in NavisXtend Provisioning Server Programmer's Reference, Product Code: 80066, Revision 02, dated October 1999, the contents of which are expressly incorporated herein by reference.

The provisioning server 128 invokes the interface by accessing a table in the system database 130, looking up the facilities involved in the provisioning step, retrieving the appropriate protocol requirements and formatting the dequeued step in compliance with the retrieved protocol.

In one embodiment of the invention, there are three tables used to determine which RT and OCD to provision, the type of the network element (e.g., Alcatel LiteSpan 2000 or AFC UMC 1000) and the associated interface or protocol. The tables are stored in the system database 130.

The first table is a Remote Terminal Cross-Reference Table, which includes a RT target identifier (TID) to identify the RT serving the subscriber terminal, along with the IP and port addresses of the COT connected to the target RT, the EMS (if any) that controls the COT, the OCD connected to the target RT and the EMS that controls the OCD. The second table is a Network Element Table, which includes for every network element an IP Address, a port address and a network element type code indicating the type of network element (i.e., manufacturer, make and model number). The third table is a Network Element Type Table, which includes the network element type code for each network element and the associated specific interface service name.

Using the facility assignment data that specifies the target RT, the provisioning server 128 queries the Remote Terminal Cross-Reference Table to determine every connected network element (e.g., COT and OCD) and associated EMSs. RT TID is based upon the common language location identifier (CLLI) code, which provides unique identification numbers for each network element. Using the IP and port addresses retrieved from the Remote Terminal Cross-Reference Table, the provisioning server 128 queries the Network Element Table to obtain the network element type associated with each of the identified network elements. Using the network element type retrieved from the Network Element Table, the provisioning server 128 queries the Network Element Type Table to retrieve the specific interface module name associated with each of the identified network elements. The interface module name is then invoked, i.e., the particular interface routine is called, by the provisioning server 128. Each particular interface routine supports a specific protocol, including, for example, Alcatel's LiteSpan TL1 messages, AFC's UMC 1000 TL1 command set and Lucent's NavisCore EMS protocol.

The Remote Terminal Cross-Reference Table is maintained by the network provider using the GUI 120. When an RT is installed in the network, an entry is made in the Remote Terminal Cross-Reference Table, along with the IP and port addresses for each element associated with the new RT. This information is referred to as the network topology for the RT. The Network Element Table is also maintained by the network provider via the GUI 120. Each COT and OCD, along with each EMS managing the COT or OCD, is entered in this table. The network element type field is populated with a specific code chosen from a specific drop-down box on the screen of the GUI 120, which prevents illegal data from being entered. The Network Element Type Table is maintained by the network provider, such that each entry corresponds to a specific interface. Because of the intricacies associated with the interfaces, the Network Element Type Table may be appropriately maintained by the technical staff of the network provider, as opposed to the administrative staff.

At step s416, the respective IP port addresses associated with the identified facilities, e.g., the RT 102, the RT controller 110, the OCD 104 and/or the EMS 116, are determined. The IP address of each facility is stored, along with the corresponding protocols based on vendor architecture, in a table in the system database 130, as discussed above. With the IP addresses, the provisioning server 128 is able to begin provisioning the dequeued step.

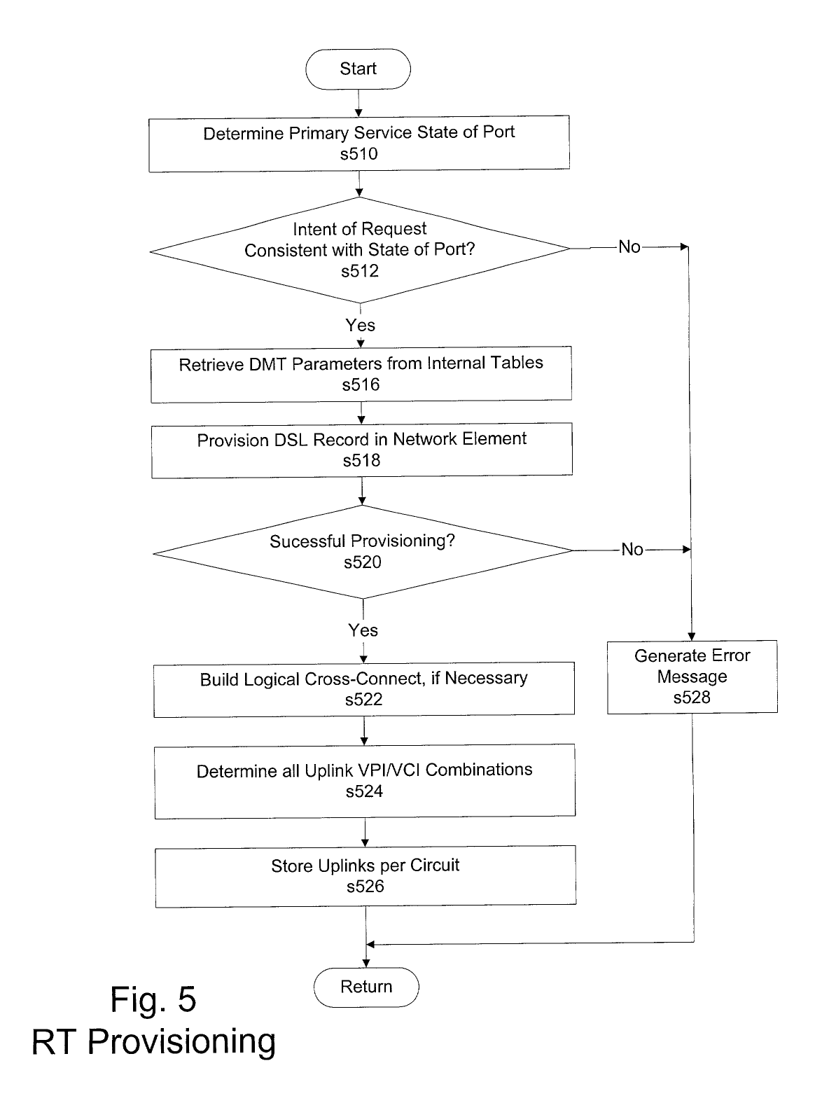

At step s418, RT processing or OCD processing is selected based on the network element type determined at step s412. If the network element type and corresponding interface is for an RT, the process proceeds to process step s420, which is developed in FIG. 5.

The RT provisioning begins at step s510 of FIG. 5 by determining the primary service state of the subscriber's port 101, identified at step s416, above. The primary service state of the subscriber's port 101 is then compared to the intent of the DSL request at step s512 to determine whether the state of the port 101 and the intent of the request are consistent. An inconsistency results in the generation of an error message at step s528. For example, if the primary service state of the port 101 is “in service” and the intent of the request is to provision DSL services, then an error message is generated at step 528. Likewise, if the primary service state of the port 101 is “out of service” and the intent of the request is to disconnect DSL services, then an error message is generated at step s528. The identity and/or the content of the error messages are displayed to the provider via the GUI 120, as discussed below.

When the comparison at step s512 indicates a consistent result, the DMT parameters relating to the request are retrieved from the system database 130 at step s516 and the DSL record is provisioned in the network element at step s518, based on the retrieved DMT parameters. The DMT parameters are built via the CLEC GUI 122, for example. The If the provisioning server 128 determines at step s520 that the provisioning of the network element was not successful, an error message is generated at step s528. Otherwise, if the provisioning was successful, the process proceeds to step s522.

At step s522, a logical cross-connection is built in the RT 102, if necessary. Whether logical cross-connections are necessary for the RT 102 depends on the facilities and the requested implementation. For example, certain RTs include preexisting cross-connections that simply need to be identified, based on subscriber port identity, rather than built. Building cross-connections across RTs is well known in the art and thus not further described.

At step s524, the RT 102 determines the communications path combinations to accommodate the requested connection. For example, the RT 102 may determine, in a known manner, the uplink VPI and VCI combinations based on connecting the subscriber port 101 with the OCD 104 through the OCD-side RT port 103. Some RT architectures, which incorporate an EMS, dynamically assign VPI and VCI values; the RT 102 queries the VPI and VCI values from the serving EMS. Other RT architectures calculate the VPI and VCI values, using an algorithm, for example, based upon specific port assignments and the type of DSL service being provisioned. Regardless of the method, the resulting VPI and VCI values must be unique with respect to the specific RT and OCD ports. The VPI and VCI values are compared with the VPI and VCI values currently in use to ensure that they are available. An attempt to provision a duplicate VPI and VCI combination will result in an error. Because service orders contain specific due dates, validation of the VPI and VCI values must consider whether they will be in use at the time the service order is due. Pending disconnect orders must likewise be considered.

At step s526, the VPI and VCI values are stored in relation to the corresponding circuit for subsequent use in provisioning the OCD 104, as discussed below. The process then returns to step s430 of FIG. 4 to determine whether the RT provisioning process has been completed successfully prior to returning to step s410 to dequeue subsequent provisioning steps. Because DSL provisioning involves dividing each service order into at least one RT step and a related OCD step, as discussed above with respect to steps s220-s224 of FIG. 2, each RT provisioning process is followed by at least one OCD provisioning process, unless the RT provisioning process results in an error. It is therefore anticipated that the provisioning process depicted in FIG. 4 will return to step s410 at least one more time to dequeue and process the OCD provisioning step that corresponds to the RT provisioning step.

The specific commands necessary to implement the RT provisioning of FIG. 5 depend on the type of facilities involved. For example, if the RT 102 is an Alcatel LiteSpan 2012, the appropriate commands are provided in the Alcatel LiteSpan—2012 Access Platform TL1 Messages, OSP363-355-502 (Draft 3), dated Feb. 21, 2000, identified above. An exemplary provisioning of an Alcatel LiteSpan 2012 for connecting an ADSL service includes the following sequential TL1 commands: ACT-USER (i.e., activate user), which logs the network provider into the LiteSpan system; RTRV-CRS-VP (i.e., retrieve virtual path cross-connections), which retrieves the provisioning data record for virtual path cross-connections from a database; RTRV-ADSL (i.e., retrieve ADSL), which retrieves database records for the ASDL facility; ENT-ADSL (i.e., enter ADSL), which enables entry of provisioning records; and CANC-USER (i.e., cancel user), which logs the network provider out of the LiteSpan system. An exemplary provisioning of an Alcatel LiteSpan 2012 for disconnecting an ADSL service includes the following sequential TL1 commands: ACT-USER, which logs the network provider into the LiteSpan system; RTRV-CRS-VP, which retrieves the provisioning data record for virtual path cross-connections from a database; ED-ADSL (i.e., edit ADSL), which enables editing of provisioning information for the ADSL facility; DLT-ADSL (i.e., delete ADSL facility), which deletes the provisioning information for the ASDL facility; and CANC-USER, which logs the network provider out of the LiteSpan system. Implementation of these exemplary TL1 commands, along with associated parameter usage, is well known.

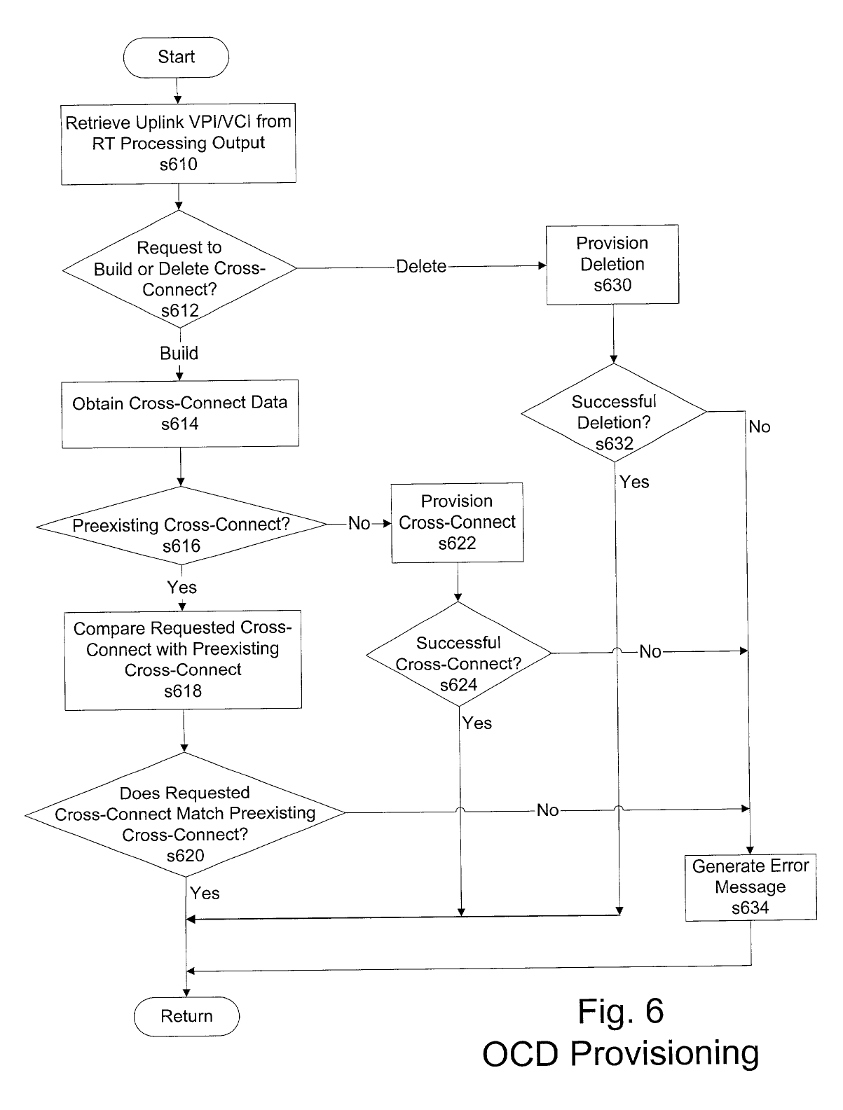

When at step s418 of FIG. 4 the provisioning server 128 determines that the interface identified at step s414 is for an OCD, the logic proceeds to process step s422, which is developed in FIG. 6. In particular, the OCD provisioning process begins at step s610 of FIG. 6 by retrieving the stored communication path data determined by the related RT provisioning process, as discussed in regard to FIG. 5, above.

At step s612, the provisioning server 128 determines whether the intent of the particular service order is to build or delete a cross-connection in the OCD 104 to accommodate the previously identified subscriber port 101 and OCD-side RT port 103. When the request is to build a logical cross-connection, the logical cross-connection data is obtained from a database internal to the OCD 104, which may be in table form, at step s614. The cross-connection data includes, for example, the DLS type (e.g., UBR, CBR and VBR), forward and reverse traffic descriptors and forward and reverse quality of service. Also, service profiles specific to the CLEC 106 are retrieved from the system database 130, or alternatively, from the service order.

When a cross-connection related to the specific subscriber port 101 already exists in the OCD 104, as determined at step s616, the requested cross-connection is compared to the existing cross-connection at step s618. If the cross-connections match, as determined at step s620, the process returns to FIG. 4, where the order is deemed successful at step s430. If the cross-connections do not match, an error message is generated at step s634. When no cross-connection exists at step s616, the requested cross-connection is provisioned in a known manner at step s622, the success of which is tested at step s624. When the cross-connection provisioning is successful, the process returns to FIG. 4; when the cross-connection provisioning is not successful, an error message is generated at step s634. Error handling is discussed in detail, below.

When the provisioning server 128 determines at step s612 that the request is to delete a cross-connection, the cross-connection is simply deleted at step s630. When the cross-connection deletion is successful, as determined at step s632, the process returns to FIG. 4. When the cross-connection deletion is not successful, or when the cross-connection identified for deletion does not exist, an error message is generated at step s634.

The specific functions necessary to implement the OCD provisioning of FIG. 6 depend on the type of facilities involved. For example, if the OCD 104 is in a Lucent CBX-500 or GX-550 switch, it must be provisioned through a compatible EMS 116, such as NavisCore/NavisXtend, also available from Lucent. The appropriate API functions for programming the EMS 116 are provided in the NavisXtend Provisioning Server Programmer's Reference, Product Code: 80066, Revision 02, dated October 1999, identified above. Provisioning the OCD 104 through a NavisCore/NavisXtend EMS involves several sequential steps, which may include calling numerous API functions.

The following are exemplary, general provisioning steps in a NavisXtend interface for enabling connection of an ADSL service. The steps include sequential activity comments and select high-level API functions, which may call additional API functions:

Receive provision request

Service Order 267231/1/73UAFU382039-014PT

get_ctid<73UAFU382039-014PT>

convert_xconnect→2/128

convert_xconnect→2/128

Activity type=A

fid_vci→43

fid_vpi→51

fid_xocd→730BFU382010-008PT

get_ocdip<SNJSCAU281401CEC103>

ocd_session

ocd_close 0

split_hostname<150.234.251.134:4001>

Connect to 150.234.251.134:4001 as userid/userpw

service order add

convert_servname→SNJSCAU281401CEC103

create_serv_endpoint<155.243.200.41/SNJSCAU281401CEC103>2-128

Endpoint Network.155.243.200.0.ServiceName.SNJSCAU281401 CEC 103.vpi.2.vci.128

convert_servname→730BFU382010-008PT

create_serv_endpoint<155.243.200.41/730BFU382010-008PT>51-43

Endpoint Network.155.243.200.0.ServiceName.73OBFU382010-008PT.vpi.51.vci.43

create_circuit_args for 73UAFU382039-014PT

Args-Name 73UAFU382039-014PT-Endpoint2 Network. 155.243.200.0.ServiceName.730BFU382010-008PT.vpi.51. vci.43-AdminStatus Up-FwdTrafficDescTypeDefaultBest Effort-FwdQOSClass UBR-RevTrafficDescType DefaultBestEffort-RevQOSClass UBR

AddObject returns 0

ocd_close b7470

Update interface status of 150.234.251.134:4001 to <Success>

tpreturn (TPSUCCESS)

The following are exemplary, general provisioning steps in a NavisXtend interface for disconnecting an ADSL service; the steps include sequential activity comments and select API function, which may call additional API functions:

Receive provision request

Service Order 299591/1/20UAFU382033-642PT

get_ctid<20UAFU382033-642PT>

convert_xconnect→6/324

convert_xconnect→6/324

Activity type=D

fid_vci→83

fid_vpi→5

fid_xocd→20OBFU382010-007PT

get_ocdip<SKTNCAU007700CEV101>

ocd_session

ocd_close 0

split_hostname<150.234.251.134:4001>

Connect to 150.234.251.134:4001 as userid/userpw

service_order_delete

convert_servname→SKTNCAU007700CEV 101

create_serv_endpoint<155.243.207.25/SKTNCAU007700 CEV101>6-324

Endpoint Network.155.243.207.0.ServiceName.SKTNCAU007700 CEV101.vpi.6.vci.324

ocd_close b7470

Update interface status of 150.234.251.134:4001 to <Success>

tpretum (TPSUCCESS)

Although the exemplary provisioning steps listed above disclose a high-level of programming, specific implementations for each type of OCD 104 and associated EMS 116, as well as the lower level commands and functions, are well known.

After execution of a provisioning process, the provisioning server 128 verifies at step s430 whether the order has been completed successfully, i.e., all requested additional cross-connections are built and disconnected cross-connections are deleted. When the order has not been successfully completed, an error message is generated at step s438 and the status of the order in the historical tracking records is set to “error” at step s440.

Errors are generated at various points throughout the provisioning process, as discussed above. Because a variety of errors can occur while editing and provisioning a service order, the respective error resolutions vary. Flexibility to handle each scenario is achieved by establishing sets of error conditions. Each error is identified by a unique code stored in a reference table in the system database 130. Each table entry contains error text and resolution text. An error message is issued to the service order placement system 112, e.g., the SOAC, that issued the service order and, in an embodiment of the invention, the error text and optionally, resolution text is displayed at the GUI 120.

There are three basic error categories. First, there are errors related to service order content and format that cannot be corrected by the provider. Orders that cannot be corrected result in an appropriate error message sent to the service order placement system 112, which simply responds, for example, by reinitiating the particular corrected service order. Second, there are errors related to service order content and format that can be corrected by the provider. Errors that can be corrected are displayed at the GUI 120, allowing the provider to evaluate each error and interactively enter instructions to correct the error, re-enter the affected portions of the service order or otherwise remedy the situation. Third, there are errors that occur during the provisioning of the network element. Provisioning errors are also displayed at the GUI 120, allowing the provider to identify the cause, potentially correct the affected network element configuration and resubmit the provisioning step that encountered the error.

When at step s430 of FIG. 4 the provisioning server 128 determines that the order has been successfully completed, the corresponding provisioned data is stored in the system database 130 at step s432. The provisioning server 128 then determines at step s434 whether any steps remain in the queue for the particular order. If there are remaining steps, the process returns to step s410 to dequeue the next step for provisioning and the process of FIG. 4 is repeated. Otherwise, the status of the order in the historical tracking records is set to “complete” at step s436, indicating that the DSL service order has been successfully implemented for the subscriber.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A method for provisioning a digital subscriber line (DSL) service in a telecommunications network, the method comprising:
receiving at a provisioning server a service order requesting the DSL service from a service order entry system;
assigning a plurality of facilities needed to implement the service order based on provisioning data indicated by the service order, the plurality of facilities comprising at least a remote terminal connectable to a terminal of a DSL subscriber and an optical concentrator device connectable to the remote terminal;
determining an interface corresponding to each of the plurality of facilities, each interface converting the service order data into a specific protocol corresponding to the assigned facility; and
configuring each of the plurality of facilities, using the corresponding interface, to implement the service order based on instructions from the provisioning server.

2. The method for provisioning a DSL service according to claim 1, further comprising:
determining at least one path interconnecting the plurality of facilities and a subscriber port of the remote terminal, the subscriber port being configured to connect with the DSL subscriber terminal.

3. The method for provisioning a DSL service according to claim 2, further comprising:
determining and implementing a cross-connection in at least one of the plurality of facilities to enable the at least one path interconnecting the plurality of facilities and the subscriber port.

4. The method for provisioning a DSL service according to claim 3, further comprising:
storing configuration data in a system database, the configuration data comprising data identifying the plurality of facilities assigned to implement the service order, the at least one path interconnecting the plurality of facilities and the subscriber port of the remote terminal, and the cross-connection in the at least one of the plurality of facilities.

5. The method for provisioning a DSL service according to claim 1, wherein the provisioning data is derived based on the provisioning data indication in the service order.

6. The method for provisioning a DSL service according to claim 1, wherein the service order indicates the provisioning data by at least one of providing the provisioning data and providing a profile identification that corresponds to parameters that define the DSL service.

7. The method for provisioning a DSL service according to claim 1, further comprising:
determining whether the service order comprises erroneous data; and
when the service order is determined to comprise erroneous data, displaying at a graphical user interface an error message, which identifies the erroneous data, and receiving input from the graphical user interface to correct the erroneous data.

8. A method for provisioning a digital subscriber line (DSL) service in a telecommunications network, the method comprising:
receiving a service order at a common server via a service order entry system, the service order corresponding to a DSL subscriber;
converting the service order into provisionable steps;
determining facility assignment data related to each of a plurality of facilities needed to implement the provisionable steps, the facility assignment data comprising identification of at least a remote terminal and a subscriber port, connectable to a terminal of the DSL subscriber, and an optical concentrator device connectable to the remote terminal;
determining an interface for each of the plurality of facilities, each interface enabling communication with the corresponding one of the plurality of facilities; and
configuring each of the plurality of facilities to implement the service order based on instructions communicated from the common server to each of the plurality of facilities using the corresponding interface.

9. The method for provisioning a DSL service according to claim 8, further comprising:
formatting data from the service order into a common internal format prior to converting the service order into provisional steps.

10. The method for provisioning a DSL service according to claim 8, further comprising:
validating an intent of the service order with respect to a state of a port of the remote terminal associated with the DSL subscriber and provisioning the service order in the remote terminal upon successful validation.

11. The method for provisioning a DSL service according to claim 8, further comprising:
identifying errors related to at least one of the service order and the provisioning of the DSL service; and
displaying information regarding the errors at a graphical user interface, the graphical user interface being configured to enable a user to analyze and respond to the errors.

12. The method for provisioning a DSL service according to claim 8, the configuring each of the plurality of facilities to implement the service order comprising one of building, deleting or changing at least one virtual path over an optical fiber connection between the remote terminal and the optical concentrator device.

13. The method for provisioning a DSL service according to claim 12, the building of at least one virtual path over an optical fiber connection between the remote terminal and the optical concentrator device comprising:
providing a network-side port at the remote terminal configured to connect with the subscriber port;
communicating to the optical concentrator device the identity of the network-side port; and
configuring the optical concentrator device to support the virtual path to the network-side port of the remote terminal.

14. The method for provisioning a DSL service according to claim 12, the deleting of at least one virtual path over an optical fiber connection between the remote terminal and the optical concentrator device comprising:
disconnecting a network-side port at the remote terminal from the subscriber port;
communicating to the optical concentrator device the identity of the network-side port; and
configuring the optical concentrator device to delete support of the virtual path to the network-side port of the remote terminal.

15. The method for provisioning a DSL service according to claim 8, the configuring each of the plurality of facilities to implement the service order comprising one of building, deleting or changing at least one cross-connection in at least one of the plurality of facilities.

16. The method for provisioning a DSL service according to claim 8, further comprising:
enqueuing the provisionable steps after determining the facility assignment data related to each of a plurality of facilities needed to implement the provisionable steps; and
sequentially dequeuing the provisionable steps for implementation on a scheduled provisioning date, prior to determining the interface for each of the plurality of facilities.

17. The method for provisioning a DSL service according to claim 8, further comprising:
receiving service profile data related to at least one service from a service provider, the service profile data comprising at least one parameter related to the service order;
storing the service profile data in a system database; and
configuring each of the plurality of facilities to implement the service order additionally based on the service profile data.

18. A system for provisioning a digital subscriber line (DSL) service in a telecommunications network, the system comprising:
a server that receives a service order for the DSL service from a service order entry system;
a plurality of network facilities connectable to the server and a terminal of a DSL subscriber; and
a system database that stores the service order and a plurality of interfaces corresponding to the plurality of network facilities;
wherein the server assigns provisioning facilities from among the plurality of network facilities needed to implement the service order, the provisioning facilities comprising at least one remote terminal and at least one optical concentrator device, the remote terminal being connectable to the optical concentrator device via an optical fiber line; and
wherein the server directs configuration of each of the provisioning facilities, using an interface identifier retrieved from the system database corresponding to each of the provisioning facilities, to implement the service order.

19. The system for provisioning a DSL service according to claim 18, the remote terminal comprising a subscriber port, the subscriber port being configured to connect with a DSL subscriber terminal, wherein the server enables at least one path interconnecting the plurality of facilities and the subscriber port of the remote terminal.

20. The system for provisioning a DSL service according to claim 19, wherein the at least one of the remote terminal and the optical concentrator device determine and implement a cross-connection to enable the at least one path interconnecting the plurality of facilities and the subscriber port.

21. The system for provisioning a DSL service according to claim 20, the system database comprising configuration data that identifies the plurality of facilities assigned to implement the service order, the at least one path interconnecting the plurality of facilities and the subscriber port of the remote terminal, and the cross-connection in the at least one of the plurality of facilities.

22. The system for provisioning a DSL service according to claim 18, further comprising:
a graphical user interface connected to the server and configured to interface with the server, the system database and at least one of the plurality of network elements.

23. The system for provisioning a DSL service according to claim 22, wherein, when the service order comprises erroneous data, the graphical user interface displays an error message, which identifies the erroneous data, and receives input from an operator in response to the erroneous data.

24. A system for provisioning a digital subscriber line (DSL) service in a telecommunications network, the system comprising:
a service order entry system that receives a service order for the DSL service from a DSL service provider;
a server that receives the service order from the service order entry system;
a plurality of network facilities connectable to the server and a terminal of a subscriber desiring the DSL service;
a facility inventory system connected to the server that stores facility information regarding each of the plurality of network facilities, the facility information comprising a type, a location and an availability of each of the plurality of network facilities; and
a system database connected to the server that stores data relating to the service order and a plurality of interfaces corresponding to the plurality of network facilities;
wherein the server communicates with the facility inventory system to determine provisioning facilities from among the plurality of network facilities needed to implement the service order received from the service order entry system, the provisioning facilities comprising at least one remote terminal and a subscriber port and at least one optical concentrator device, the remote terminal being connectable to the optical concentrator device via an optical fiber line; and
wherein the server directs configuration of each of the provisioning facilities using a corresponding one of the plurality of interfaces retrieved from the system database to implement the service order.

25. The system for provisioning a DSL service according to claim 24, further comprising:
a graphical user interface connectable to the server that enables interaction by a network operator with at least one of the server, the plurality of network facilities and the system database.

26. The system for provisioning a DSL service according to claim 25, wherein the server identifies errors related to at least one of the service order and the provisioning of the DSL service; and
wherein information regarding the errors is displayed at the graphical user interface and error responses are sent from the graphical user interface to the server.

27. The system for provisioning a DSL service according to claim 24, wherein the configuration of each of the provisioning facilities, using a corresponding one of the plurality of interfaces retrieved from the system database to implement the service order, comprises one of building, deleting or changing at least one virtual path over the optical fiber connection between the remote terminal and the optical concentrator device.

28. The system for provisioning a DSL service according to claim 27, wherein the building of at least one virtual path over the optical fiber connection between the remote terminal and the optical concentrator device comprises:
providing a network-side port at the remote terminal configured to connect with the subscriber port;
communicating to the optical concentrator device the identity of the network-side port; and
configuring the optical concentrator device to support the virtual path to the network-side port of the remote terminal.

29. The system for provisioning a DSL service according to claim 27, wherein the deleting of at least one virtual path over the optical fiber connection between the remote terminal and the optical concentrator device comprises:
disconnecting a network-side port at the remote terminal from the subscriber port;
communicating to the optical concentrator device the identity of the network-side port; and
configuring the optical concentrator device to delete support of the virtual path to the network-side port of the remote terminal.

30. The system for provisioning a DSL service according to claim 24, further comprising an interface configured to connect a graphical user interface of the DSL service provider with the server;
wherein the system database stores service profile data related to at least one service of the DSL service provider, the service profile data comprising at least one parameter related to the service order; and
wherein provisioning facilities are configured to implement the service order additionally based on the service profile data.

31. A computer readable medium for storing a computer program that provisions a digital subscriber line (DSL) service in a telecommunications network, the computer readable medium comprising:
a receiving source code segment that receives a service order requesting the DSL service from a service order entry system;
an assigning source code segment that assigns a plurality of facilities needed to implement the service order based on provisioning data indicated by the service order, the plurality of facilities comprising at least a remote terminal connectable to a terminal of a DSL subscriber and an optical concentrator device connectable to the remote terminal;
a determining source code segment that determines an interface corresponding to each of the plurality of facilities, each interface converting the service order data into a specific protocol corresponding to the assigned facility; and
a configuring source code segment that configures each of the plurality of facilities, using the corresponding interface, to implement the service order based on instructions from a provisioning server.

32. The computer readable medium for storing a computer program according to claim 31 further comprising:
a path determining source code segment that determines at least one path interconnecting the plurality of facilities and a subscriber port of the remote terminal, the subscriber port being configured to connect with the DSL subscriber terminal.

33. The computer readable medium for storing a computer program according to claim 32 further comprising:
a cross-section determining source code segment that determines and implements a cross-connection in at least one of the plurality of facilities to enable the at least one path interconnecting the plurality of facilities and the subscriber port.

34. The computer readable medium for storing a computer program according to claim 33 further comprising:
a memory source code segment that stores configuration data in a system database, the configuration data comprising data identifying the plurality of facilities assigned to implement the service order, the at least one path interconnecting the plurality of facilities and the subscriber port of the remote terminal, and the cross-connection in the at least one of the plurality of facilities.

35. The computer readable medium for storing a computer program according to claim 31 wherein the provisioning data is derived based on the provisioning data indication in the service order.

36. The computer readable medium for storing a computer program according to claim 31 wherein the service order indicates the provisioning data by at least one of providing the provisioning data and providing a profile identification that corresponds to parameters that define the DSL service.

37. The computer readable medium for storing a computer program according to claim 31 further comprising:
an error detection source code segment that determines whether the service order comprises erroneous data and, when the service order is determined to comprise erroneous data, initiates display at a graphical user interface of an error message, which identifies the erroneous data, and receives input from the graphical user interface to correct the erroneous data.

38. A computer readable medium for storing a computer program that provisions a digital subscriber line (DSL) service in a telecommunications network, the computer readable medium comprising:
a receiving source code segment that receives a service order at a common server via a service order entry system, the service order corresponding to a DSL subscriber;
a converting source code segment that converts the service order into provisionable steps;
a facility assignment source code segment that determines facility assignment data related to each of a plurality of facilities needed to implement the provisionable steps, the facility assignment data comprising identification of at least a remote terminal and a subscriber port, connectable to a terminal of the DSL subscriber, and an optical concentrator device connectable to the remote terminal;
an interface determining source code segment that determines an interface for each of the plurality of facilities, each interface enabling communication with the corresponding one of the plurality of facilities; and
configuring source code segment that configures each of the plurality of facilities to implement the service order based on instructions communicated from the common server to each of the plurality of facilities using the corresponding interface.
